(19) United States
(12) Patent Application Publication
(10) Pub. No.: US 2009/0285463 A1
(43) Pub. Date: Nov. 19, 2009

(54) Superresolution parallel magnetic resonance imaging

(76) Inventors: Ricardo Otazo, New York, NY (US); Stefan Posse, Albuquerque, NM (US)

Correspondence Address: Stefan Posse, 1616 Bayita Ln NW, Albuquerque, NM, 87107, US

(21) Appl. No.: 12/386,446

(22) Filed: Apr. 17, 2009

Related U.S. Application Data
(60) Provisional application No. 61/046,334, filed on Apr. 18, 2008.

(51) Int. Cl. G06K 9/00

(52) U.S. Cl. 382/131

(57) ABSTRACT

The present invention includes a method for parallel magnetic resonance imaging termed Superresolution Sensitivity Encoding (SURE-SENSE) and its application to functional and spectroscopic magnetic resonance imaging. SURE-SENSE acceleration is performed by acquiring only the central region of k-space instead of increasing the sampling distance over the complete k-space matrix and reconstruction is explicitly based on intra-voxel coil sensitivity variation. SURE-SENSE image reconstruction is formulated as a superresolution imaging problem where a collection of low resolution images acquired with multiple receiver coils are combined into a single image with higher spatial resolution using coil sensitivity maps acquired with high spatial resolution. The effective acceleration of conventional gradient encoding is given by the gain in spatial resolution Since SURE-SENSE is an ill-posed inverse problem, Tikhonov regularization is employed to control noise amplification. Unlike standard SENSE, SURE-SENSE allows acceleration along all encoding directions.

### REFERENCE TO RELATED APPLICATIONS

Applicant claims priority of U.S. Provisional Application No. 61/046,334, filed on Apr. 18, 2008 for Superresolution Parallel Magentic Resonance Imaging of Ricardo Otazo and Stefan Posse, Applicants herein.

### FEDERALLY SPONSORED RESEARCH

The present invention was made with government support under Grant No. 1 R01 DA14178-01 awarded by the National Institutes of Health. As a result, the Government has certain rights in this invention.

### BACKGROUND OF THE INVENTION

1. Technical Field of the Invention

This invention relates to parallel magnetic resonance imaging techniques where multiple receiver coils are used simultaneously to acquire the spatially-encoded magnetic resonance signal with fewer phase-encoding gradient steps in order to accelerate the acquisition process.

2. Description of the Prior Art

Magnetic resonance imaging (MRI) methods involve imaging objects with high spatial frequency content in a limited amount of time. However, information over only a limited k-space range is usually acquired in practice due to SNR and time constraints. For example, in functional MRI (fMRI) k-space coverage is traded off for increased temporal resolution. In MR spectroscopic imaging (MRSI), which is constrained by relatively low SNR, k-space coverage is sacrificed to achieve an adequate SNR within a feasible acquisition time. The lack of high k-space information leads to limited spatial resolution and Gibbs ringing when the Fourier transform is directly applied to reconstruct the image. Constrained image reconstruction techniques using prior information have been proposed to achieve superresolution image reconstruction, i.e. to estimate high k-space values without actually measuring them. For example, the finite spatial support of an image can be used to perform extrapolation of k-space at expense of SNR loss. However, this method performs well only at positions close to the periphery of the object being imaged. For experiments with temporal repetitions such as fMRI and MRSI; k-space substitution, also known as the key-hole method, was proposed to fill the missing high k-space values of the series of low resolution acquisitions using a high resolution reference. However, this method is vulnerable to artifacts due to inconsistencies between the reference and the actual acquisition. An improvement of this approach, known as generalized series reconstruction, forms a parametric model using the high resolution reference to fit the series of low resolution acquisitions and thus reduce the effect of data replacement inconsistencies. Alternatively, superresolution reconstruction can be performed by combination of several low resolution images acquired with sub-pixel differences. This method is well developed for picture and video applications and was employed before in MRI by applying a sub-pixel spatial shift to each of the low resolution acquisitions. However, its application is very limited since a spatial shift is equivalent to a linear phase modulation in k-space, which does not represent new information to increase the k-space coverage of the acquisition.

Parallel MRI has been introduced as a method to accelerate the sequential gradient-encoding process by reconstructing an image from fewer acquired k-space points using multiple receiver coils with different spatially-varying sensitivities. The standard strategy for acceleration is to reduce the density of k-space sampling beyond the Nyquist limit while maintaining the k-space extension in order to preserve the spatial resolution of the fully sampled acquisition. The rationale for this sub-sampling scheme is that the coil sensitivities are spatially smooth and retrieve k-space information only from the neighborhood of the actual gradient-encoding point. From this point onwards, we refer as standard SENSE to the image-domain unfolding of aliased images acquired with uniform sub-sampling of k-space as described in the paper “SENSE: sensitivity encoding for fast MRI” by Pruessmann et al. in Magnetic Resonance in Medicine 42(5) 1999, pages 952-962. However, any arbitrary k-space sub-sampling pattern can in principle be employed at the expense of increasing the computational cost and decreasing the stability of the inverse reconstruction as described in the paper “A generalized approach to parallel magnetic resonance imaging” by Sodickson et al. in Medical Physics 28(8) 2001, pages 1629-43. On the other hand, standard parallel MRI performed at a spatial resolution that presents intra-voxel coil sensitivity variation suffers from residual aliasing artifacts which are depicted as spurious side lobes around the aliasing positions in the reconstructed point spread function (PSF). The minimum-norm SENSE (MN-SENSE) technique was proposed to remove the residual aliasing artifact by performing an intra-voxel reconstruction of the PSF using coil sensitivities acquired with higher spatial resolution as it is described in the paper “Minimum-norm reconstruction for sensitivity-encoded magnetic resonance spectroscopic imaging” by Sanchez-Gonzalez et al. in Magnetic Resonance in Medicine 55(2) 2006, pages 287-295. However, while this method improves the spatial distinctiveness of image voxels, it does not increase the number of voxels and hence the underlying spatial resolution.

Receiver arrays with a large number of small coils tend to have rapidly varying coil sensitivity profiles, and therefore offer the promise of high accelerations for parallel imaging. However, standard SENSE reconstruction with many-element arrays is exposed to residual aliasing artifacts due to potential intra-voxel coil sensitivity variations. On the other hand, many-element arrays open the door for other k-space sub-sampling patterns that might not be feasible with few-element arrays. For example, highly accelerated parallel imaging using only one gradient-encoding step was proposed in the Single Echo Acquisition (SEA) technique with a 64-channel planar array as described in the paper “64-channel array coil for single echo acquisition magnetic resonance imaging” in Magnetic Resonance in Medicine 56(2) 2005, pages 386-392; and in the Inverse Imaging (InI) technique with a 90-channel helmet array for human brain fMRI as described in the paper “Dynamic magnetic resonance inverse imaging of human brain function” in Magnetic Resonance in Medicine 56(4) 2006, pages 787-802. However, the price to pay for these extreme levels of acceleration is reconstruction with low spatial resolution as dictated by the degree of variation of the coil sensitivity maps.

As such, there is a need in the art for a magnetic resonance imaging method that increases the spatial resolution of intrinsically low resolution techniques and for a parallel magnetic resonance imaging method that employs the intra-voxel coil sensitivity variation as reconstruction basis.

### SUMMARY OF THE PRESENT INVENTION

The present invention includes a method for parallel MRI termed Superresolution SENSE (SURE-SENSE) and its application to fMRI and MRSI to increase the spatio-temporal resolution. The proposed method reduces the acquisition time by acquiring only the central region of k-space and reconstructs an image with higher target spatial resolution by using coil sensitivities acquired with higher resolution. The reconstruction is formulated as an inverse problem. Regularization of the ill-conditioned inverse reconstruction is performed to control noise amplification due to the relatively large weights required to reconstruct high k-space values from low resolution data. The attainable increase in spatial resolution is determined by the degree of variation of the coil sensitivities within the acquired image voxel.

### BRIEF DESCRIPTION OF THE DRAWINGS

FIG. 1 is a conceptual illustration of the superresolution parallel MRI technique

FIG. 2 is a flowchart of the reconstruction process.

FIG. 3 shows reconstructed images for a simulation experiment using a Shepp-Logan.

FIG. 4 shows the application the SURE-SENSE method to functional MRI.

FIG. 5 shows activation maps for the functional MRI experiment

FIG. 6 shows water, lipids, NAA and Creatine concentration maps for the spectroscopic imaging experiment

FIG. 7 shows absorption mode spectra and corresponding LCModel fit for the spectroscopic imaging experiment.

### DETAILED DESCRIPTION OF THE INVENTION

The system and method of the present invention are described herein with reference to their preferred embodiments. It should be understood by those skilled in the art of magnetic resonance imaging that numerous variations of these preferred embodiments can be readily devised, and that the scope of the present invention is defined exclusively in the appended claims.

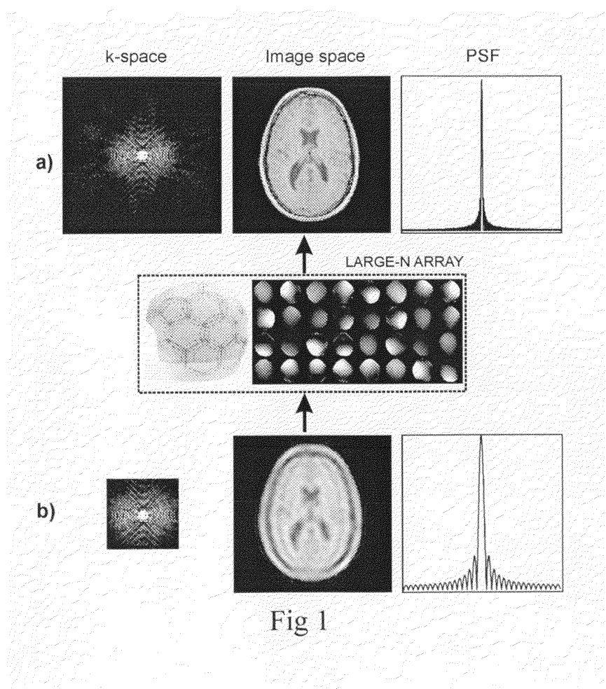

FIG. 1 shows the superresolution SENSE idea where a single image with higher spatial resolution is reconstructed from fully-sampled low resolution images acquired with multiple receiver coils using high resolution coil sensitivity maps. Since the image acquired by each coil is weighted by the corresponding spatial sensitivity of the coil, superresolution reconstruction is feasible if the different sensitivities are varying within the low resolution image voxel.

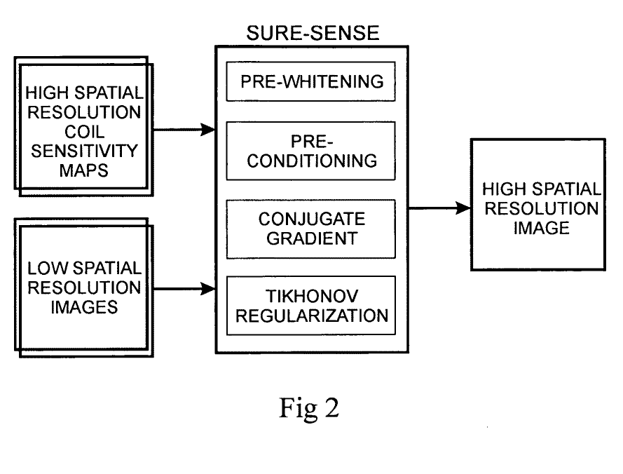

FIG. 2 shows the flowchart of the reconstruction process. SURE-SENSE is formulated in the image domain following the generalized parallel imaging model for arbitrary sub-sampling trajectories considering that image data are acquired from a central k-space region and coil sensitivity data are acquired from an extended k-space region. Both data sets are acquired on a grid given by the Nyquist sampling distance (Δk=1/FOV, where FOV is the field of view). The signal acquired by each coil can be represented as:

$${S}_{l} ( k ) = {\int }_{r} ρ ( r ) {c}_{l} ( r ) {e}^{j 2 π k \cdot r} d r , l = 1 , 2 , … , {N}_{c} , \qquad ( 1 )$$

where r is the position vector,

$$k = \frac{γ}{2 π} {\int }_{0}^{t} G ( τ ) d τ$$

is the k-space vector determined by the gradient vector G(t), ρ(r) is the object function, cₗ(r) is the complex-valued spatially-varying coil sensitivity and N_{c} is the number of coils. Considering the acquisition of Nₖ image data points and Nₛ sensitivity points (Nₛ=RNₖ, where R is the overall sampling reduction factor), a discretized version of Eq. (1) in matrix form, is given by:

F_{N}_{ₖ}sₗ=πF_{N}_{ₛ}Cₗρ, (2)

where Fₙ(n×n) is the spatial discrete Fourier transform (DFT) matrix, sₗ(Nₖ×1) is the low resolution image vector for the l-th coil, C, (Nₛ×Nₛ) is a diagonal matrix containing the l-th coil sensitivity values along the diagonal, and ρ(Nₛ×1) is the target object function at high spatial resolution. π(Nₖ×Nₛ) is the low-pass k-space filter operator, where the element π(i,j) is equal to 1 if the k-space position with index j is sampled and equal to 0 otherwise. The encoding equation for the l-th coil in the image domain can be expressed as:

sₗ=F_{N}_{ₖ}⁻¹πF_{N}_{ₛ}Cₗρ=Eₗρ. (3)

Note that F_{N}_{ₖ}⁻¹πF_{N}_{ₛ} represents the low-pass k-space filter in the image domain. The complete encoding equation is obtained by concatenating the individual encoding equations:

$$s = E ρ , s = [ \begin{matrix}{s}_{1} \\ ⋮ \\ {s}_{{N}_{c}}\end{matrix} ] , E = [ \begin{matrix}{E}_{1} \\ ⋮ \\ {E}_{{N}_{c}}\end{matrix} ] , \qquad ( 4 )$$

where s is the multi-coil image vector at low resolution (NₖN_{c}×1) and E is the encoding matrix (NₖN_{c}×Nₛ). Noise correlation between coils is removed by pre-whitening the image vector and the encoding matrix using the noise covariance matrix estimated from a noise-only acquisition. Pre-whitening is performed by

$${x}_{w} = {Ψ}^{- \frac{1}{2}} x ,$$

where Ψ(N_{c}×N_{c}) is the noise covariance matrix for the array coil and x_{w}(N_{c}×1) is the multi-coil data. Ψ was estimated using a sample average estimate from a noise-only acquisition (nₜ) switching off the RF excitation:

$$\hat{Ψ} = \frac{1}{{N}_{t}} {\sum }_{t = 1}^{{N}_{t}} ( {n}_{t} - \overline{n} ) {( {n}_{t} - \overline{n} )}^{H} , \qquad ( 5 )$$

where Nₜ is the number of time points and n̅(N_{c}×1) is the average over time of nₜ.

The proposed k-space sub-sampling pattern, which reduces the extent of sampled k-space while maintaining the Nyquist sampling distance, allows for acceleration along the readout dimension. Two-dimensional acceleration of imaging sequences with two spatial dimensions will therefore be feasible with SURE-SENSE, unlike with standard SENSE where the acceleration is limited to the phase-encoding dimension. Two-dimensional acceleration provides better conditioning of the inverse problem and thus allows for higher acceleration factors than one-dimensional acceleration for the same overall acceleration factor when an array with two-dimensional coil sensitivity encoding is employed.

The inverse of the encoding equation will provide an image reconstructed onto the superresolution grid, where the acquired low resolution data are fitted to delta functions in the high resolution grid using the high resolution coil sensitivities. Direct inversion will result in large noise amplification since the encoding matrix for SURE-SENSE is intrinsically ill-conditioned as compared with standard SENSE due to the lower coil sensitivity variation within the low resolution voxel than across aliased voxels. Tikhonov regularization is employed to control the noise amplification in the reconstruction (g-factor). The least-squares solution using Tikhonov regularization with diagonal weighting can be represented as:

$$\hat{ρ} = arg {min}_{ρ} \{ {‖ E ρ - s ‖}_{2}^{2} + {λ}^{2} {‖ ρ ‖}_{2}^{2} \} , \qquad ( 6 )$$

where λ is the regularization parameter. Tikhonov regularization constrains the power of the solution (∥ρ∥₂²) thus controlling noise amplification while attenuating solution components with low singular values compared to λ. The Tikhonov weighting function for the i-th singular value σᵢ is given by

$${w}_{i} = \frac{{σ}_{i}^{2}}{{σ}_{i}^{2} + {λ}^{2}} ,$$

which presents a smooth roll-off behavior along the singular value spectrum instead of the sharp cut-off imposed by other techniques such as the truncated singular value decomposition (TSVD). The regularization parameter (λ²) was set to the average power of the high resolution reference used for sensitivity calibration to attenuate components with a low squared singular value compared to the average power of the reference. For the SURE-SENSE encoding matrix, low singular values represent high spatial frequency components, and therefore the regularization approach trades off SNR and spatial resolution. The nominal gain in spatial resolution is given by inversion of the encoding matrix without regularization. The effective gain in spatial resolution is dictated by the degree of regularization necessary to achieve an adequate SNR.

SURE-SENSE reconstruction requires the inversion of the complete encoding matrix. ID-SURE is implemented using a line-by-line matrix inversion approach. 2D-SURE is implemented using a conjugate gradient (CG) solution with pre-conditioning as in the case of non-Cartesian SENSE. For SURE-SENSE, density correction and regridding are not performed since the reconstruction lies on a Cartesian grid. Considering the original normal equations from Eq. (6) (E^{H}E+λ²I)ρ=E^{H}s, the CG iterations are applied to the following transformed system:

P(E^{H}E+λ²I)Pbᵢ=PE^{H}s, (7)

where the elements of the diagonal pre-conditioning matrix P are given by

$${p}_{i , i} = {( {\sum }_{l = 1}^{{N}_{c}} {\vert {c}_{l} ( {r}_{i} ) \vert}^{2} + λ )}^{- \frac{1}{2}}$$

and bᵢ is the partial result for the i-th iteration. The final result after Nᵢ iterations is then given by \hat{ρ}=Pb_{N}_{ₗ}.

The spatial resolution of the reconstruction was analyzed using the full-width at half-maximum (FWHM) of the point spread function (PSF). The effective gain in spatial resolution is defined as K=FWHM-DFT/FWHM-SURE, where FWHM-DFT is the FWHM of the conventional DFT reconstruction of the low resolution data with k-space zero-filling and FWHM-SURE is the FWHM of the SURE-SENSE reconstruction. The nominal gain in spatial resolution is given by K using the FWHM of SURE-SENSE without regularization. The PSF for each spatial position r was obtained by reconstructing the low resolution representation of a single source point located at r. The source point is modeled as a delta function at the corresponding voxel position, which is multiplied by the high resolution coil sensitivities and passed trough the low-pass filter. The PSF is given by the resulting SURE-SENSE reconstruction of the low resolution source point.

Noise amplification in the inverse reconstruction was assessed using the g-factor formalism. For ID-SURE, the analytical g-factor was computed using the matrix E. For the conjugate gradient reconstruction, the g-factor was computed by reconstructing a time-series of simulated noise-only images (Gaussian distribution, mean: 0, standard deviation: 1) with and without SURE acceleration. The corresponding g-factor is given by the ratio

$$\frac{{σ}_{SURE} ( r )}{\sqrt{R} \times {σ}_{FULL} ( r )} ,$$

where σ_{SURE}(r) and σ_{FULL}(r) are the standard deviations along the time dimension for each of the noise-only reconstructions and R is the overall sampling reduction factor (Eggers et al., 2005).

Using the property that the SNR in MRI is proportional to the square root of the acquisition time and the voxel volume; the SNR of SURE-SENSE reconstruction (SNR_{SURE}) with respect to the SNR of the low resolution DFT reconstruction (SNR_{low}) is given by:

$${SNR}_{SURE} = \frac{{SNR}_{low}}{K g} , \qquad ( 8 )$$

where K is the effective spatial resolution gain and g is the noise amplification factor as defined above. Note that the SNR is spatially varying since all the quantities involved are spatially varying. Using the same property, the relationship between SNR_{SURE} and the SNR of the fully-sampled DFT reconstruction (SNR_{full}) is given by:

$${SNR}_{SURE} = \frac{\sqrt{R}}{K g} {SNR}_{full} . \qquad ( 9 )$$

Note that if the effective gain in spatial resolution approaches the theoretical limit (K=R), Eq. (9) is similar to the SNR relationship in standard SENSE.

Simulation experiment: simulation with two spatial dimensions were performed using the Biot-Savart model of the 32-element head array coil with soccer-ball geometry which is used in the in vivo experiments and the Shepp-Logan phantom as object function. Coil sensitivity maps were simulated using a field of view of 220×220 mm² and an image matrix of 128×128. Noise-free multi-coil data was generated by multiplying the numerical phantom with the sensitivity maps. Gaussian noise corresponding to SNR=100 was added to simulate the SNR that might be measured in an fMRI experiment. 2D superresolution factors of 2×2 and 4×4 were tested on the low resolution data given by the central 64×64 and 32×32 k-space region of the full k-space data respectively.

In vivo experiments: human brain data were acquired using a 3 Tesla MR scanner (Tim Trio, Siemens Medical Solutions, Erlangen, Germany) equipped with Sonata gradients (maximum amplitude: 40 mT/m, slew rate: 200 mT/m/ms). A 32-element head array coil with soccer-ball geometry which provides sensitivity encoding along all the spatial dimensions was used for RF reception, while RF transmission was performed with a quadrature body coil. Coil sensitivity calibration was performed using unprocessed in vivo sensitivity references. In this approach, multi-coil reference images are employed directly as coil sensitivities to solve the inverse problem, followed by post multiplication by the sum-of-squares combination of the reference images to remove additional magnetization density information introduced by the use of the unprocessed reference images. In other words, the image reconstructed by the inversion of an encoding matrix constructed from raw coil reference data is the pixelwise quotient of the true image and the reference combination; therefore the true image can be recovered by post-multiplying the result by the reference combination. This approach is preferred, since the spatial smoothing inherent in explicit coil sensitivity estimation methods such as polynomial fitting may limit the performance of SURE-SENSE.

Functional MRI experiment: a visual stimulation experiment with 8 blocks of 16 seconds of visual fixation and 16 seconds of flashing checkerboard was performed. Single slice data were acquired using an interleaved echo-planar imaging (EPI) sequence (repetition time (TR): 4 s, echo time (TE): 30 ms, spatial matrix: 256×256, field of view (FOV): 220×220 mm², slice thickness: 3.4 mm, 64 scan repetitions). The high resolution reference was obtained from the first scan using the full k-space matrix and SURE-SENSE reconstruction was applied to the following down-sampled scan repetitions. The down-sampled data is given by the central 32×32 k-space data discarding the outer k-space data. In order to have a target spatial resolution with sufficient intra-voxel coil sensitivity variation, SURE-SENSE reconstruction was performed using the 32×32 central k-space matrix with a 64×64 target k-space matrix, which represents a two-dimensional sampling reduction factor of R=2×2. A 64×64 k-space matrix is usually employed in fMRI with high temporal resolution. For comparison, the original fully-sampled 64×64 data and the down-sampled 32×32 data were conventionally reconstructed by applying a discrete Fourier transform (DFT) to each channel and the composite image was computed using a sensitivity-weighted combination. Additionally, a standard SENSE reconstruction was applied to a regularly undersampled data set with reduction factor of R=4×1, i.e. the fully-sampled 64×64 k-space data matrix was decimated by keeping the first row of every consecutive four rows. Note that standard SENSE does not allow for acceleration of the readout dimension therefore a higher one-dimensional acceleration was used to match the SURE-SENSE acceleration. Correlation and region of interest (ROI) analyses were performed using the TurboFire software package with a correlation coefficient threshold of 0.6, i.e. both positive correlation values above 0.6 and negative correlation values below −0.6 were included in the activation map. The reference vector defined by the stimulation paradigm was convolved with the canonical hemodynamic response function defined in SPM99. Motion correction and spatial filters were not employed. Average SNR was computed as the ratio of the mean value and standard deviation of the reconstructed time-series data along the temporal dimension.

MR spectroscopic imaging experiment: human brain MRSI data with two spatial dimensions were acquired with Proton Echo Planar Spectroscopic Imaging (PEPSI) (Posse et al., 1995) in axial orientation using a 64×64×512 spatial-spectral matrix (x,y,v) where x and y are the spatial dimensions and ν is the spectral dimension. The FOV was 256×256 mm² and the slice thickness was 20 mm resulting in a nominal voxel size of 320 mm³ (in-plane nominal pixel size was 4×4 mm²). Data were filtered in k-space using a Hamming window which increased the voxel size to 820 mm³ (in plane effective pixel size was 6.4×6.4 mm²). The spectral width was set to 1087 Hz. The 2D-PEPSI sequence consisted of water-suppression (WS), outer-volume-suppression (OVS), spin-echo RF excitation, phase-encoding for y and the echo-planar readout module for simultaneous encoding of x and t. Data acquisition included water-suppressed (WS) and non-water-suppressed (NWS) scans. The NWS scan was performed without the WS and OVS modules and it is used for spectral phase correction, eddy current correction and absolute metabolite concentration. The high resolution NWS and WS PEPSI data sets were acquired in 2 min each using single signal average, TR=2 s and TE=15 ms. Data were collected with 2-fold oversampling for each readout gradient separately to improve regridding performance and using a ramp sampling delay of 8 μs to limit chemical shift artifacts. Regridding was applied to correct for ramp sampling distortion of the kₓ-t trajectory. Spectral water images from the high resolution NWS data were employed for coil sensitivity calibration as described before in our SENSE-PEPSI implementations. SURE-SENSE was applied to the central 32×32 k-space matrix using the 64×64 coil sensitivities, which represents a two-dimensional sampling reduction factor of R=2×2. Water images were obtained by spectral integration of the reconstructed NWS data. Lipid images were computed by spectral integration of the reconstructed WS data from 0 to 2.0 ppm. Metabolite images were obtained by spectral fitting using LCModel with analytically modeled basis sets. Spectral fitting errors in LCModel were computed using the Cramer-Rao Lower Bound (CRLB, the lowest bound of the standard deviation of the estimated metabolite concentration expressed as percentage of this concentration), which when multiplied by 2.0 represent 95% confidence intervals of the estimated concentration values. A threshold of 30% was imposed on the CRLB to accept voxels in the metabolite concentration maps. Average SNR in the WS data was computed using the SNR value from LCModel which is given by the ratio of the maximum in the spectrum-minus-baseline over the analysis window to twice the standard deviation of the residuals. Error maps were computed as the difference with respect to the concentration map from the fully-sampled DFT reconstruction.

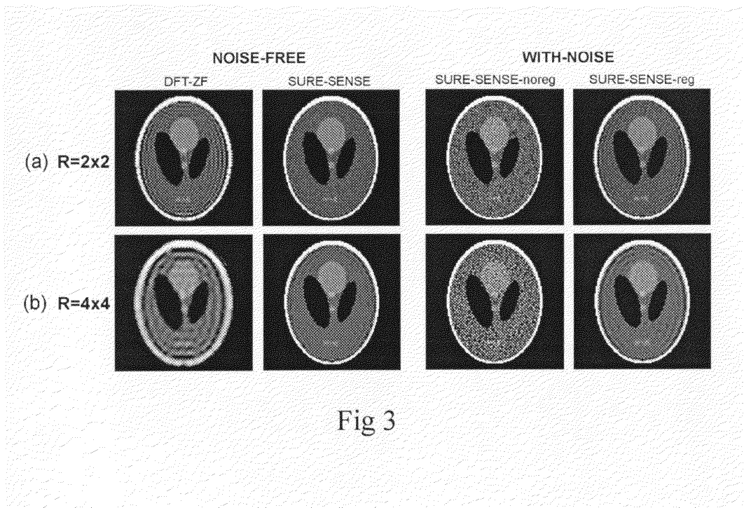

FIG. 3 shows the results from the simulation experiment. The noise-free SURE-SENSE reconstruction with R=2×2 was similar to the target object presenting an effective gain close to the theoretical 2×2 increase in spatial resolution (FIG. 3.a). Two-dimensional acceleration presents lower and more uniform noise amplification than using a high one-dimensional acceleration. For R=4×4, the noise free SURE-SENSE reconstruction is less similar to the target object presenting slight blurring at the center of the image and residual Gibbs ringing due to the more stringent requirements on the intra-voxel coil sensitivity variations to allow for 16-fold increase in spatial resolution. Nevertheless, the SURE-SENSE reconstruction presents a significant increase in spatial resolution when comparing to the DFT-ZF reconstruction. However, this ideal increase in spatial resolution imposed an SNR penalty as it is shown in the SURE-SENSE reconstruction without regularization in the case of noisy data. SURE-SENSE with Tikhonov regularization controlled the noise amplification in the inverse reconstruction at the expense of reducing the gain in spatial resolution. Note that the SNR penalty is higher for R=4×4 as expected from the larger k-space extrapolation region to recover the full k-space data. Even though the target spatial resolution was not feasible due to the SNR penalty, SURE-SENSE reconstruction with regularization presented a significant gain in spatial resolution and reduction of Gibbs ringing when compared to the conventional DFT with zero-filling reconstruction of the low resolution data.

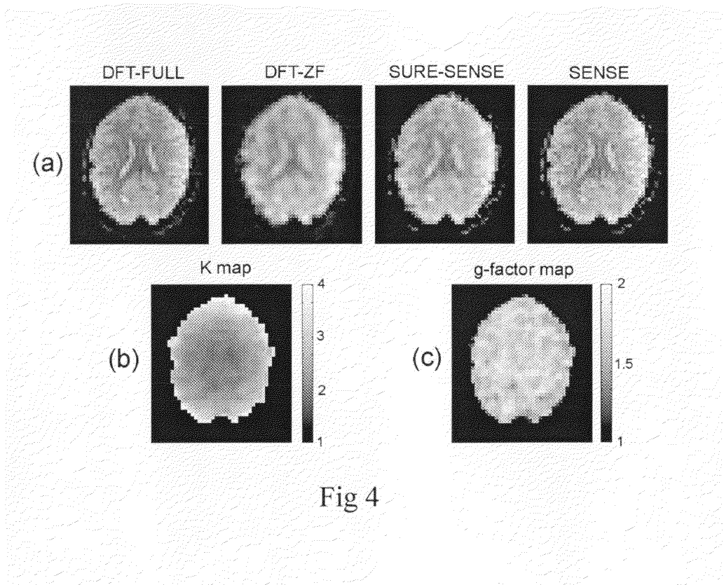

FIG. 4 shows the results from the functional MRI experiment. SURE-SENSE reconstruction of the low spatial resolution time-series fMRI data yielded a significant increase in spatial resolution when compared to the DFT reconstruction with zero-filling. The gain in spatial resolution is spatially varying, with higher values at positions where the coil sensitivity variation is stronger, e.g. in the periphery of the brain for the soccer-ball array coil. The average gain in spatial resolution was a factor of 2.51 with a maximum value of 3.87 (very close to the theoretical gain of 4) in peripheral regions and a minimum value of 1.55 in central regions where the coil sensitivities are broad and overlapped. This behavior can be explained considering that the regularization approach is broadening the PSF at positions with high nominal g-factor in order to obtain an adequate SNR. The resulting g-factor map after regularization presented a homogeneous distribution with a mean value of 1.54±0.44. Note that without regularization the g-factor map will look inhomogeneous with high values at regions with less intra-voxel coil sensitivity variation, e.g. central region for the soccer-ball array. The average SNR computed from the reconstructed time-series data was 14.4 for the fully-sampled DFT reconstruction, 23.9 for the zero-filled DFT reconstruction and 8.6 for SURE-SENSE. The average SNR for SURE-SENSE is higher than the value predicted by Eq. (8) (6.2), and by Eq. (9) (7.5), which is in part due to the relatively small number of temporal points used to estimate the SNR (64) and the effect of the shape of the PSF which is not completely taken into account since the factor K in Eq. (8) and Eq. (9) is just a FWHM ratio. Nevertheless, they are approximately in the range predicted by Eq. (8) and Eq. (9). Standard SENSE reconstruction of data regularly undersampled by a factor of R=4×1 to match the SURE-SENSE reduction factor resulted in residual aliasing artifacts and localized noise enhancement whereas the spatial resolution was homogeneous and similar to the fully-sampled DFT reconstruction. Note that standard SENSE only removes the aliasing at the center of the voxel and residual aliasing artifacts due to intra-voxel coil sensitivity variations are present in the reconstructed image. The Tikhonov regularization along with pre-conditioning presented a fast and stable reconstruction for SURE-SENSE using the conjugate gradient algorithm with 12 iterations. Note that without the Tikhonov term the g-factor continuously increases with the number of iterations and the stopping point should be selected before convergence to maintain adequate SNR. The total reconstruction time was approximately 2 minutes (2 seconds per temporal repetition) using Matlab (The MathWorks, Natick, Mass.) on a 64-bit quad core workstation.

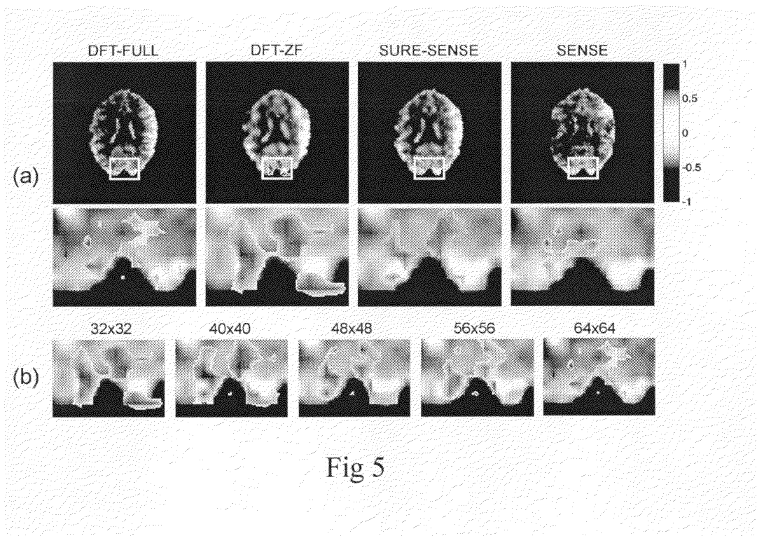

FIG. 5 shows the activation maps from the functional MRI experiment. Visual activation maps obtained from the time series data reconstructed with SURE-SENSE displayed a spatial pattern closer to the maps from the fully-sampled data when comparing to the zero-filled DFT reconstruction. The activation pattern with zero-filled DFT reconstruction is smooth due to partial volume effects and areas with small signal decrease become visible due to increased SNR in the low spatial resolution data. The activation pattern of SURE-SENSE is spatially more localized than in the zero-filled DFT reconstruction as expected from the increase in spatial resolution and the areas with negative signal changes are less visible due to increased noise level, similar to the high resolution data. SURE-SENSE presented an activation map with spatially-varying spatial resolution following the pattern given by the K-map. FIG. 5.b shows the activation maps for conventional DFT with zero-filling reconstruction of k-space data acquired with different spatial resolutions. The activation map for SURE-SENSE is very close to the DFT-64×64 (full k-space data) at the edges of the brain where the pattern is very discrete. As we move towards the center, the SURE-SENSE map falls in between the DFT-49×40 and DFT-48×48 which is consistent with the 2.5-fold increase in spatial resolution predicted by the K-map for that region. The activation map of standard SENSE reconstruction also suffered from some blurring and additionally presented smaller spatial extent of activation than the DFT-64×64 reconstruction (FIG. 5.a) due to increased noise level. This decrease in spatial extent of activation is also more localized at the upper right part of the activation region, which is due in part to the residual aliasing in that region.

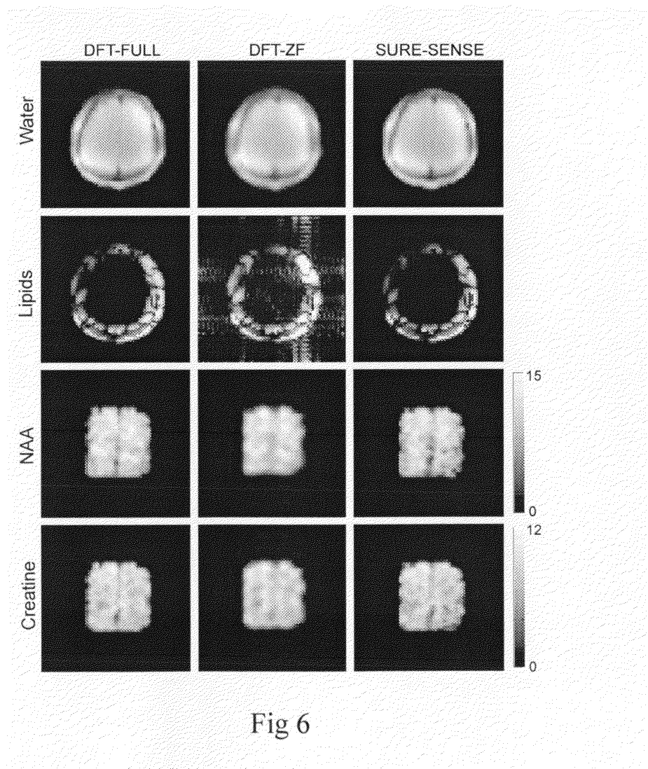

FIG. 6 shows the results from the spectroscopic imaging experiment. SURE-SENSE reconstruction reduced the strong effect of k-space truncation in the low spatial resolution PEPSI data set, resulting in metabolite maps with improved spatial resolution and spectra with reduced lipid contamination as compared to the DFT with zero-filling reconstruction. The spatial resolution gain and g-factor maps displayed a similar pattern as in the fMRI experiment, since the same coil array, acceleration factor and image matrix were employed. The average gain in spatial resolution was 2.37 with a maximum value of 3.72 in peripheral regions and a minimum value of 1.48 in central regions. The average g-factor was 1.49±0.36. The average SNR of the WS reconstructed data was 11.4 for the fully-sampled DFT reconstruction, 19.8 for the zero-filled DFT reconstruction and 7.9 for SURE-SENSE. These values are approximately in the range predicted by Eq. (8) (5.7) and Eq. (9) (6.5). The maps of NAA and creatine for SURE-SENSE were similar to ones from the DFT reconstruction of the full k-space data. Average error with respect to map derived from the full k-space data were 8.9% for NAA and 8.2% for creatine. The average errors of the corresponding zero-filled DFT reconstruction NAA and creatine maps were 24.1% and 22.9%.

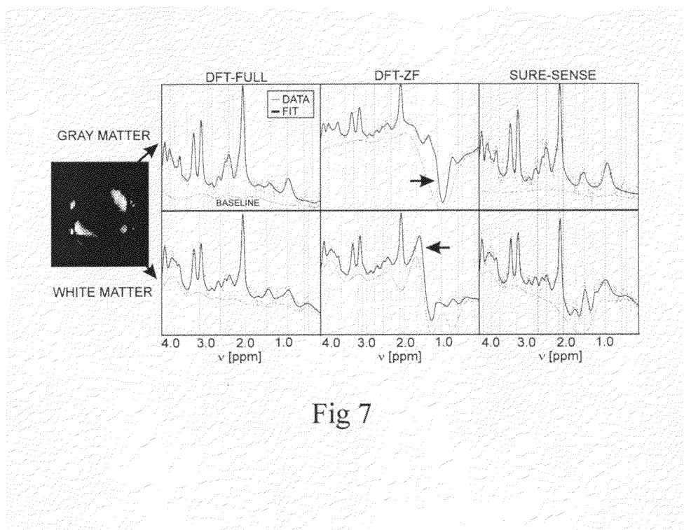

FIG. 7 shows spectra examples from the spectroscopic imaging experiment. The accuracy of spectral quantification as indicated by the CRLB decreased for SURE-SENSE as compared to the fully-sampled DFT reconstruction due to the lower SNR and the presence of residual lipid contamination. However, the strong lipid contamination in the zero-filled DFT reconstruction was highly reduced by SURE-SENSE resulting in CRLB values decreased by a factor of 1.46 for NAA and 1.38 for creatine on average.

A GRAPPA-based SURE reconstruction (SURE-GRAPPA) uses a separate fully-sampled acquisition with the target spatial resolution which will be used as ACS information. The weights in this case will be computed to estimate high k-space values from low k-space sampled data, i.e. k-space extrapolation. A GRAPPA operator that reduces the amount of high k-space values necessary to derive the weights enables sparser ACS data acquisition. The GRAPPA algorithm finds the best weight (or combination of weights) using a least square combination of the resulting individual fits. Since the sampling scheme is regular, only one set of weights needs to be estimated. With SURE-GRAPPA the sampling scheme is irregular and it is necessary to find weights for each shift in k-space. Here the GRAPPA operator formalism, which has been demonstrated to reduce the amount of ACS information in the reconstruction, will be useful to derive the shifts in k-space. Of note the GRAPPA operator can be applied along each spatial dimension separately.

The uniform k-space sampling pattern of the low resolution data acquisition may not be optimal for achieving optimal spatial localization with minimum cross-talk between voxels. A generalization of SURE reconstruction using a more distributed non-uniform sampling pattern that extends to the targeted k-space boundaries from the central k-space region, with decreasing sampling density towards the boundaries of the target k-space provides additional flexibility for shaping the PSF.

As a person skilled in the art will recognize from the previous detailed description and from the figures and claims, modifications and changes can be made to the preferred embodiments of the invention without departing from the scope of this invention defined in the following claims.

We claim:

1. A method for magnetic resonance imaging comprising the steps of:
(a) acquiring a plurality of low spatial resolution images of an object employing multiple radiofrequency receiver coils;
(b) acquiring a plurality of coil sensitivity maps with higher target spatial resolution; and
(c) reconstructing an image of the object with the higher target spatial resolution by fitting the acquired low resolution image data to delta functions in the high resolution spatial grid using the coil sensitivity maps with higher target spatial resolution.

2. The method of claim 1, where spatial encoding of a high resolution image is accelerated by acquiring only the low spatial frequencies (k-space) of the object.

3. The method of claim 1, where the reconstruction is performed in the spatial domain after applying a spatial Fourier transform to the k-space data.

4. The method of claim 1, where the coil sensitivity reference images are used directly to generate the multi-coil encoding matrix.

5. The method of claim 4, where the result of the inversion of said encoding matrix is multiplied pixel-by-pixel with the multi-coil combination of the reference.

6. The method of claim 1, where the computation of the multi-coil encoding matrix is replaced by FFT operations and vector-matrix multiplications.

7. The method of claim 1, where the inverse reconstruction is computed using conjugate gradient iterations with preconditioning, using the following pre-whitening approach, but not excluding related approaches: Pre-whitening is performed by multiplying the inverse square-root of the noise covariance matrix for the array coil with the multi-coil data. The noise covariance matrix is estimated using the sample average estimate from a noise-only data acquisition with the RF excitation switched off.

8. The method of claim 7, where Tikhonov regularization is implemented using a diagonal weighting approach.

9. The method of claim 8, where the regularization weighting parameter is selected using the power of the reference images to compute the coil sensitivity maps.

10. The method of claim 1, where the low resolution data is regularly undersampled in k-space to further increase the acceleration.

11. The method of claim 10, where the reconstruction is combined with standard SENSE/GRAPPA algorithms to remove aliasing resulting from said undersampling.

12. A method for magnetic resonance spectroscopic imaging according to claim 1 where the high spatial resolution coil sensitivity maps are obtained from a separate imaging acquisition.

13. The method of claim 12, where the reconstruction is performed separately for each time point in the spectroscopic acquisition.

14. A method for functional magnetic resonance imaging according to claim 1 where multiple image encodings are obtained in a single excitation with different spatial resolution and the high spatial resolution coil sensitivity maps are obtained from one of the image encodings to reconstruct the remaining image encodings at higher spatial resolution

15. The method of claim 1, where the reconstruction is performed in the k-space domain by fitting the central k-space region to an extended k-space region by using the coil sensitivity data with extended k-space information.

16. A system for parallel magnetic resonance imaging comprising:
(a) a magnetic resonance imaging apparatus having multiple receiver coils and means for acquiring an image;
(b) a processor adapted to receive a plurality of low spatial resolution images and a plurality of coil sensitivities with the target resolution, and to reconstruct an image with the target higher spatial resolution.
(c) a display connected to the processor and adapted to display the image reconstructed with the higher target spatial resolution.

17. The system of claim 16, where the processor can perform the reconstruction of functional MRI data in parallel for each temporal repetition by using a parallel computer.

18. The system of claim 17, where the processor can perform the reconstruction of magnetic resonance spectroscopic imaging data in parallel for each spectral point by using a parallel computer.

19. A method for magnetic resonance imaging comprising the steps of:
(a) acquiring a plurality of images of an object employing multiple radiofrequency receiver coils and a distributed non-uniform sampling pattern that extends to the targeted k-space boundaries from the central k-space region, with decreasing sampling density towards the boundaries of the target k-space;
(b) acquiring a plurality of coil sensitivity maps with higher target spatial resolution; and
(c) reconstructing an image of the object with the target spatial resolution by fitting the acquired image data to delta functions in the high resolution spatial grid using the coil sensitivity maps with higher target spatial resolution.

20. The method of claim 19, where the k-space sampling pattern density is designed to achieve a targeted shape of the point spread function, using the following approach, but not excluding related approaches: the k-space sampling density is given by the Fourier transformation of the targeted shape of the point spread function.
